(19) United States
(12) Patent Application Publication
(10) Pub. No.: US 2007/0124333 A1
(43) Pub. Date: May 31, 2007

(54) Method and apparatus for associating metadata with digital photographs

(75) Inventor: Raymond C. Bontempi, Jamison, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/288,902

(22) Filed: Nov. 29, 2005

(51) Int. Cl. G06F 7/00

(52) U.S. Cl. 707/104.1

(57) ABSTRACT

A computational device (10, 100) automatically selects metadata and presents it to a user for approval. The computational device (10, 100) compares information included in an image file with information included in a metadata database and automatically selects metadata and presents it to a user based on the comparison. If the user approves the presented metadata, the computational device (10, 100) causes the approved metadata and associated image file to be stored in a storage component.

### BACKGROUND OF THE INVENTION

1. Field of the Invention

The invention relates to archiving and retrieving digital photographs. More particularly, the invention relates to automatically associating metadata with digital photographs when storing the photographs in order to improve the archiving of the photographs and to make it easier to retrieve the photographs from storage using search criteria.

2. Description of the Related Art

When people take digital photographs, often times they eventually download the photographs to some type of storage device. For example, personal computers (PCs) are typically equipped with one or more Universal Serial Bus (USB) input/output (I/O) ports to which an I/O port on the camera may be connected via a cable in order to download photographs from a compact flash memory card of the camera to a memory device of the PC, or to a memory location on a server to which the PC is connected via a network. Rather than connecting the camera via a cable to the USB port of the PC, the compact flash memory card may be removed from the camera and inserted into a memory card reader that is connected to a USB port of the PC. The images stored on the memory card are then read by the card reader and transferred from the card reader into the designated memory location of the PC or server to which the PC is connected via a network.

A variety of image processing software programs are currently available that allow the user to control the download process and perform various types of image processing and editing tasks on the downloaded images. With most of these programs, a menu is displayed on the display monitor during the downloading process that allows the user to select the drive path designating the memory location at which the image is to be stored, and to provide a file name for the image. Once the user has selected the drive path and the file name and clicks the “OK” button, the image is stored at the designated memory location with the selected file name.

Various types of information are commonly and automatically downloaded with the digital photographic image, such as the size of the digital photographic image, the date on which the digital photographic image was captured (i.e., the date on which photograph was taken), and the time of day when the digital photographic image was captured. Therefore, the image file includes the digital photographic image as well as the image size, the capture date and the capture time. The capture date and capture time are data that the camera associates with the image when the photograph is taken.

In addition, at the time of downloading the images, the user may enter various types of textual metadata that will be stored in memory along with the image files in a way that associates the image files with the corresponding metadata. Examples of such metadata include the location where the photograph was taken, a name of the event or occasion when the photograph was taken, the person who took the photograph, etc. The user can later search the image archives for a particular image file or set of image files using various search criteria, such as file name and textual metadata.

Although these image processing software programs make it possible to associate file names and metadata with digital photographic images during the downloading process, users often do not add metadata or accurately name the image files, which presents a problem when users subsequently attempt to retrieve a particular image file during a search. When performing a search, the programs typically give the user the options of using the file name and/or metadata text to search for an image file. If the user did not associate any metadata with the image at the time of downloading the image file, the user is left with only the option of searching by file name. If the user does not remember the file name, the user is faced with having to guess the file name, and the search may be unsuccessful and/or time consuming.

For example, assuming that for a photograph taken on Christmas day in 2005, the user assigns a file name of “Christmas2005”, if the user searches files names using search criteria of “Christmas05”, “Christmas 2005”, or “Christmas '05”, for example, the search will not return the image file saved under the file name “Christmas2005”. Therefore, the search will be unsuccessful. The user may have to perform several searches using different search criteria before the user stumbles upon the correct file name and is successful at retrieving the correct image file. Dates present similar problems. For example, if the user associates a date of Nov. 15, 2005 with the file and subsequently performs a search using a date of, for example, Nov. 15, 2005 or Nov. 15, 2005, the search will not be successful.

If the user did associate textual metadata with the image file at the time of downloading, the user can retrieve the image file by searching based on the metadata text, but the user must remember the text in order for the search to be successful. Again, the user may be faced with having to guess the text, and the search may be unsuccessful and/or time consuming.

For example, assuming the user added metadata text such as, for example, “Christmas 2005”, a search that uses as the search criteria “Dec. 25, 2005” may not return the correct file because the text string used for the search does not exactly match the metadata text string. The user may have to perform several searches until the user performs a search using a text string that exactly matches the metadata text string associated with the image file. More intelligent search engines may return search results that identify image files having metadata text associated with them that does not exactly match the search text string, but that includes at least some text in common with the search text string. However, this may result in the user having to spend a considerable amount of time reviewing a large number of search results until the correct image file is located.

There are also image processing systems that are currently available that perform image recognition programs and automatically create metadata that is associated with the image when it is archived. However, such systems are relatively expensive and the metadata that is automatically created is not always accurate. In addition, the algorithms are limited to creating metadata describing the image itself, i.e., the user still is required to insert text metadata to more accurately describe the image or the circumstances surrounding the taking of the photograph. For example, the automatically created metadata may describe the image as being a photograph of a particular person, but is not capable of indicating that it was taken on the person's birthday.

A need exists for a way to associate metadata with image files that ensures that the image files will be easily and accurately archived and that the archives can be easily and quickly searched in order to retrieve the image files.

### BRIEF DESCRIPTION OF THE DRAWINGS

FIG. 1 illustrates a block diagram of an example of the apparatus.

FIG. 2 illustrates a flowchart that demonstrates an example of the method for initializing the metadata database.

FIG. 3 is a pictorial representation of a menu that is presented to the user on a display monitor during the initialization phase.

FIG. 4 illustrates a flowchart of the method for automatically presenting metadata to a user to provide the user with the option of associating the presented metadata with image files.

FIG. 5 illustrates a pictorial representation of an example of a menu that is displayed to the user during the metadata association phase.

FIG. 6 illustrates a block diagram of an example of the apparatus implemented as a media server.

FIG. 7 illustrates a pictorial representation of an example of a menu that is displayed to the user during the metadata association phase to enable the user to associate a batch of photographs taken on the same day with the same metadata.

### DETAILED DESCRIPTION OF EXEMPLARY EMBODIMENTS

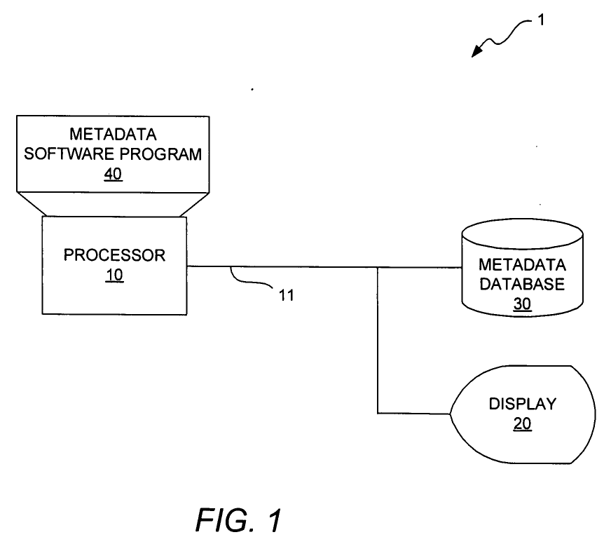

FIG. 1 illustrates a block diagram of an example of an apparatus 1 for associating metadata with digital photographs. In accordance with this example, the apparatus 1 comprises a processor 10 (e.g., a microprocessor, microcontroller, etc.) that is in communication with a display monitor 20 and a metadata database storage component 30 via a bus 11. Alternatively, the display monitor 20 and the database storage component 30 may be in communication with the processor 10 via two separate I/O buses, although more than two buses may be used. The processor 10 and metadata database storage component 30 may be part of a personal computer (PC), in which case the display monitor 20 would be connected to the PC via an input/output (I/O) bus.

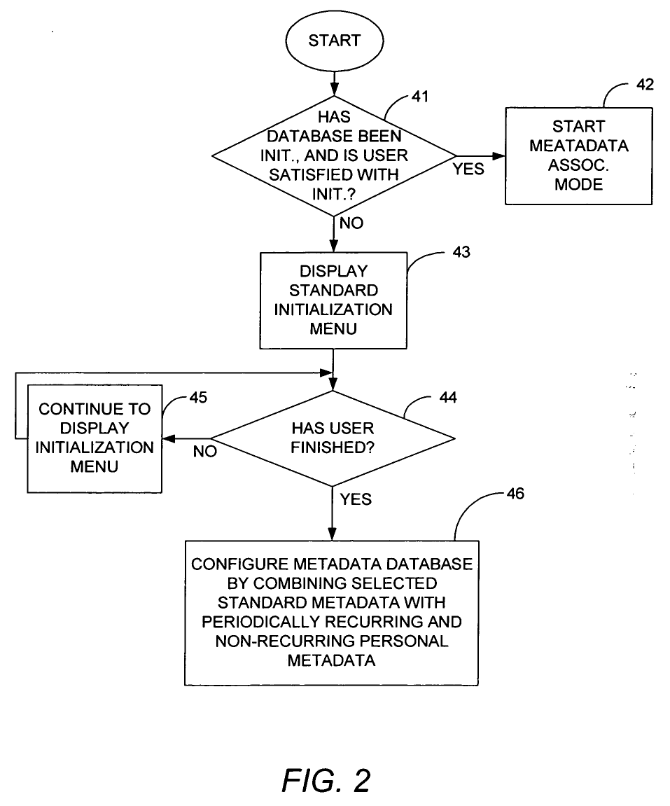

A metadata computer software program 40 is executed by the processor 10 in order to perform the metadata database initialization, metadata insertion during downloading, displaying prompts and receiving user input, archiving, and searching archives, as described below with reference to FIGS. 2-7.

A metadata database is stored in database storage component 30. The metadata database contains metadata that is automatically presented to the user by the processor 10 to provide the user with the option of authorizing the association of the presented metadata with image files. The phrase “image files”, as that phrase is used herein, is intended to denote a file that includes a digital photograph and other data, such as, for example, the date and time that the photograph was taken. Typically, the metadata is presented to the user at the time of downloading image files, although it may be presented prior to or after downloading of the image files.

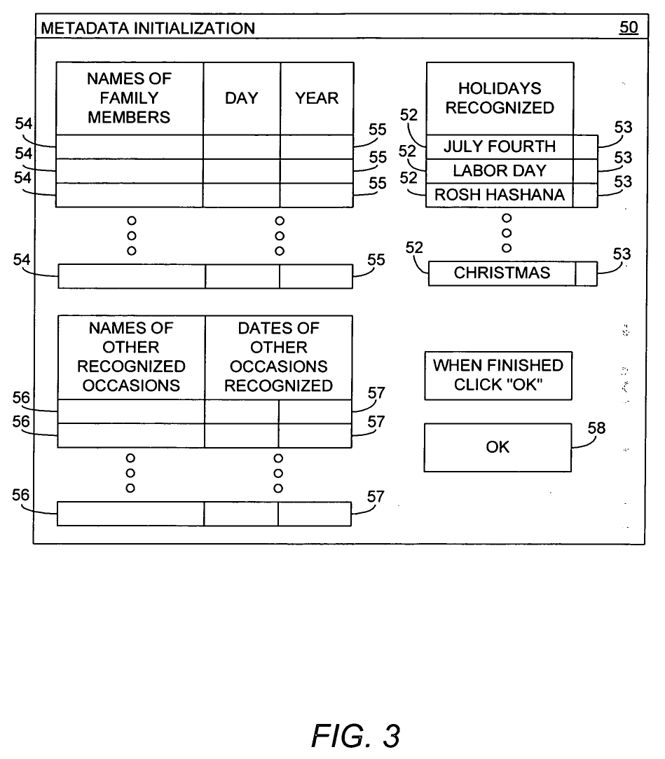

Before the processor 10 presents metadata to the user for association with an image file, the metadata database preferably is initialized by the user through a series of prompts that are displayed to the user on the display monitor 20 as standard metadata fields. The processor 10 of the apparatus 1 is programmed to execute the software program 40 that causes the prompts to be displayed on the display monitor 20. The software program 40 receives the metadata input to the computer 10 by the user in response to the prompts, and initializes the metadata database using the inputted metadata. The display monitor 20 displays the prompts and other information to the user to enable the user to easily perform database initialization. The manner in which initialization of the metadata database may be performed is described below with reference to FIGS. 2 and 3.

After the metadata database has been initialized, during a metadata association phase, the software program 40 automatically inserts certain metadata contained in the metadata database into fields that are presented to the user on the display monitor 20. As stated above, this will typically occur as the user is downloading image files, e.g., from a digital camera to a PC containing the processor 10 running program 40. The program 40 displays one or more prompts on the display monitor 20 that query the user as to whether the presented metadata is satisfactory for association with the image file. This allows the user to easily make a selection, even without using a keyboard (e.g., directly on a display touch screen monitor), indicating to the software program 40 that the metadata automatically displayed is satisfactory for association with the image file. The software program detects that the selection has been made and archives the image and the associated metadata. The manner in which presentation of metadata and association of presented metadata may be performed is described below with reference to FIGS. 2 and 3.

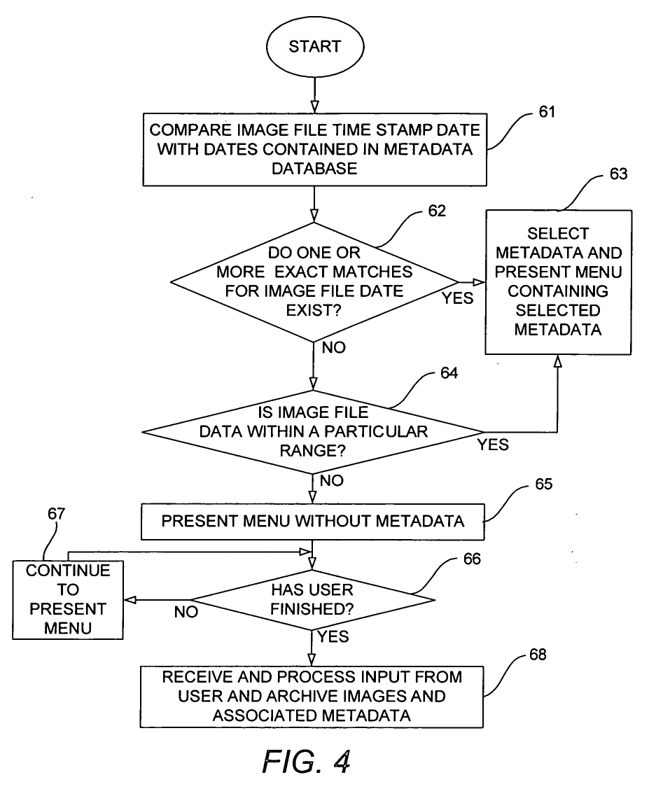

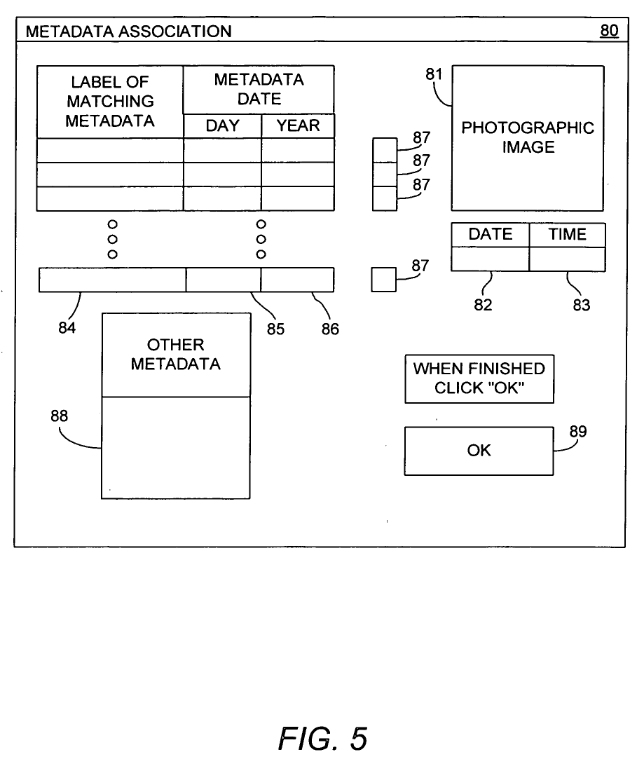

FIG. 2 illustrates a flowchart that demonstrates an example of the method for initializing the metadata database. FIG. 3 is a pictorial representation of a menu that is presented to the user on a display monitor during the initialization phase. The initialization process will be described with reference to FIGS. 4 and 5.

With reference to FIG. 2, when the user installs or first runs the program 40, the program 40 will determine whether initialization has previously been performed or whether the user is satisfied with the previous initialization, as indicated by block 41. If so, the program 40 starts the metadata association mode, as indicated by block 42 which is described below with reference to FIGS. 4 and 5. If the metadata database has not previously been initialized, or has previously been initialized but the user is not satisfied with the initialization or otherwise wants to reinitialize the database, the program 40 displays the initialization menu 50 shown in FIG. 3 to the user, as indicated by block 43.

With reference to FIG. 3, the initialization menu 50 includes a list of names of holidays 52 that are widely recognized. A box 53 is located beside each named holiday. The user selects the boxes 53 beside the names of the holidays that the user recognizes. Widely recognized days such as holidays will be referred to herein as standard metadata. Standard metadata typically will correspond to events or calendar dates that are observed over by a large sector of a population. For example, when implemented in the U.S.A., the database will typically include a field corresponding to U.S. holidays and standard names (e.g., “Labor Day”, “New Years Day”, etc.) for the holidays and the corresponding dates (e.g., first Monday in September, January 1, etc.). Thus, a standard metadata entry in the database may be, for example, “holiday/New Years Day/January 1”.

The initialization menu 50 preferably also includes fields that enable the user to enter recurring personal metadata in the form of names of family members 54 and their birthdates 55. The user types in the family members' names into boxes 54 and the corresponding birthdates into boxes 55. The initialization menu 50 preferably also includes fields that enable the user to enter types of recurring personal metadata such as anniversaries, company picnics, birthdays of non-family members, etc. The user enters the names of the occasions, special days or events in boxes 56 and the corresponding dates in boxes 57.

The personal metadata may be entered into the fields of the menu via some type of input device, such as a keyboard, a mouse, a touch screen monitor, etc. After the user has finished selecting the standard metadata and inputting the personal recurring metadata, the user selects the button 58 labeled “OK”.

With reference again to FIG. 2, when the program 40 is in the initialization mode and the menu 50 is being displayed to the user, as indicated by block 43, the program 40 will periodically or constantly check to determine whether the “OK” button 58 has been selected, as indicated by block 44. If the program 40 determines that the “OK” button 58 has not been selected, the program 40 will continue to display the menu 50, as indicated by block 45. If the program 40 determines that the “OK” button 58 has been selected, the program 40 configures the metadata database by combining the selected standard metadata with the recurring personal metadata entered by the user in boxes 56 and 57. This step, which is represented by block 46, corresponds to completion of initialization of the metadata database.

FIG. 4 illustrates a flowchart of the method in accordance with an exemplary embodiment for automatically presenting metadata to a user to provide the user with the option of associating the presented metadata with image files. FIG. 5 illustrates a pictorial diagram of an example of a menu that is displayed to the user during the metadata association phase. The manner in which metadata is automatically selected and presented to the user will now be described below with reference to FIGS. 4 and 5.

As stated above, when a digital photograph is taken, the camera automatically associates the photograph with a date and time stamp. The program 40 includes code that corresponds to a rule set that controls the process of automatically selecting metadata to be presented for approval to the user. The term “rule set”, as that term is used herein, denotes a set of guidelines that are implemented in code of the program 40 that control actions performed by the processor 10 in determining which, if any, metadata is selected for presentation to the user. The rule set controls the actions of the processor 10 such that the processor 10 can only select metadata that complies with certain criteria.

Typically, the rule set will cause the processor 10 to select only metadata from the metadata database that matches the date and/or time associated with an image file, or that is within a range of dates and or times associated with an image file. For example, if a photograph was taken on January 1, for example, the program 40 will find that this date matches the date of New Years Day in the database, assuming that this day was selected as a holiday that is recognized by the user during the initialization stage. One rule of the rule set may require the processor 10 to select only metadata that exactly matches the date stamp associated with the image file. Another may require that the processor 10 de-select the metadata if the date corresponds to a holiday that the user did not select during initialization. The program 40 may automatically generate metadata such as “Are these photos for New Years Day?”, and present it to the user in a menu displayed on the display monitor 20 with a prompt such as “If so, press “OK″”.

With reference to FIG. 4, the program 40 compares the date associated with the current image file with the dates contained in the metadata database, as indicated by block 61. A determination is then made as to whether the date associated with the image file matches a date in the metadata database, as indicated by block 62. The matching date contained in the database may be, for example, a holiday that is recognized by the user or a birthday of the user or of a family member of the user. If an exact match is found, a menu such as the menu 80 shown in FIG. 5 is presented to the user, as indicated by block 63. It may be possible for more than one matching date to be contained in the database. Therefore, the menu 80 may present multiple metadata options, one or more of which may be selected to the user.

The menu 80 shown in FIG. 5 includes the photographic image 81, and the date and time 82 and 83, respectively, when the photograph was taken. The menu includes boxes 84 that contain metadata labels. For example, if the metadata presented corresponds to the user's mother's birthday, one of the boxes 84 will contain a label such as “Mom's Birthday”. The boxes 85 and 86 will contain the dates associated with the presented metadata. For example. If mom's birthday was Jun. 22, 1945, the boxes 85 and 86 will contain “June 22^{nd}” and “1945”, respectively. Metadata may be selected based on the year and/or the day and/or the time of day.

As stated above, multiple metadata options may be selected and presented. For example, in the unlikely event that mom and dad's birthdays are on the same day, another of the boxes 84 might contain “Dad's Birthday”, and the corresponding boxes 85 and 86 may contain the date, e.g., “June 22^{nd}”, and “1939”, respectively. The boxes 87 allow the user to select one or more of the metadata options.

With reference again to FIG. 4, if no exact match between the image file date and any dates contained in the database is found, a determination is made at block 64 as to whether the date associated with the image file is within a particular range of a date contained in the database. As indicated above, the rule set may call for using ranges of dates when automatically selecting metadata to be presented to the user. For example, if the time stamp date is December 27, the rule set may include a rule that time stamp dates that range between December 24 and December 31 will be assumed to correspond to Christmas. If a match is found based on the image file date being within a particular range of days from one or more dates in the database, the corresponding metadata is selected and presented in menu 80 to the user, as indicated by block 63. An example of how this might be useful is in a case where a married couple celebrates Christmas with the wife's parents on Christmas Eve, and celebrates Christmas with the husband's parents on Christmas Day. Because December 24 and December 25 are both within the range, the rule set may be configured to make a determination that both dates correspond to Christmas Day, and thus present the corresponding metadata to the user.

If no matching metadata is found, the menu 80 is presented to the user without any proposed metadata, as indicated by block 65. Regardless of whether or not any metadata is automatically selected and presented to the user, the user may manually enter metadata in block 88 in menu 80 to be associated with the image. Once the user has finished selecting any presented metadata and/or inserting other metadata, the user selects the “OK” button 89. The program 40 periodically or constantly checks to determine whether the user has finished selecting and/or entering metadata by determining whether the “OK” button” 89 has been selected, as indicated by block 66. As long as the program 40 has not detected an indication that button 89 has been selected, the program 40 continues to present the menu. If a determination is made that button 89 has been selected, the program 40 processes the information contained in the menu and associates any selected metadata or other metadata inserted by the user with the image file, as indicated by block 68.

Another example of metadata that might be presented to the user in boxes 84 and 86 is “Christmas” and “2005”, respectively. The user may approve the presented metadata by pressing the “OK” button 89 in menu 80. If the user does not wish to use the presented metadata, the user simply does not select any of the boxes 87. Instead of selecting the presented metadata, the user may insert metadata in box 88 such as, for example, “Ski Trip to Vail 2005”. Unique metadata that corresponds to recurring events but that is not a widely recognized date, such as, for example, the company picnic, may be inserted into block 88. Metadata that is inserted into box 88 may be metadata corresponding to recurring or nonrecurring events.

The rules may also be setup to automatically select the metadata that most closely corresponds to the time stamp date. If no exact match is found in the database for a time stamp date, the rules may be setup such that metadata in the database that has a date that is closest to the time stamp date is selected and presented to the user for approval. For example, Mother's Day in the U.S. is celebrated on the second Sunday in May. The rules may be setup such that there is a one-day window on either side of Mother's Day. In other words, any date that corresponds to the day before, the day after or the day of Mother's Day will be assumed to be Mother's Day. Mother's Day was celebrated on Sunday May 8 in 2005. If the time stamp date is May 7, 2005, the metadata that is presented to the user in boxes 84 and 86 might read “Mother's Day” and “2005”. The user would then select the appropriate one of boxes 87. The exact date on which Mother's Day and certain other widely recognized days of celebration occur change from year to year. The database automatically updates itself: to stay current.

As stated above, metadata contained in the metadata database may also be selected by program 40 and presented in a menu such as menu 80 based on the date and time of day. For example, children often open Christmas gifts on Christmas morning. If the date and time stamp that are associated with the image file when the photograph is taken are Dec. 25, 2005 and 8:15 A.M., respectively, the metadata that is selected and presented to the user may be “opening gifts on Christmas Day” and “2005”. Alternatively, if the date and time stamp that are associated with the image file when the photograph is taken are Dec. 25, 2005 and 9:15 P.M., respectively, the metadata that is selected and presented to the user may be “Christmas Dinner” and “2005”, respectively. In an alternative embodiment, time fields may be included in one or both of the menus shown in FIGS. 3 and 5 to enable time of day to be used as metadata to be associated with an image file.

The archives of image files and associated metadata may be organized as a picture library that may be searched using pulldown menus and/or keywords in the typical manner in which searches are currently performed using available image viewing software programs. In addition, instant photo albums can be generated using pulldown menus and/or keywords, e.g., “Christmas” or “2005” or “Christmas 2005”. The metadata with which the image file has been associated may also be stored in the metadata database 30, or in a separate storage component (not shown).

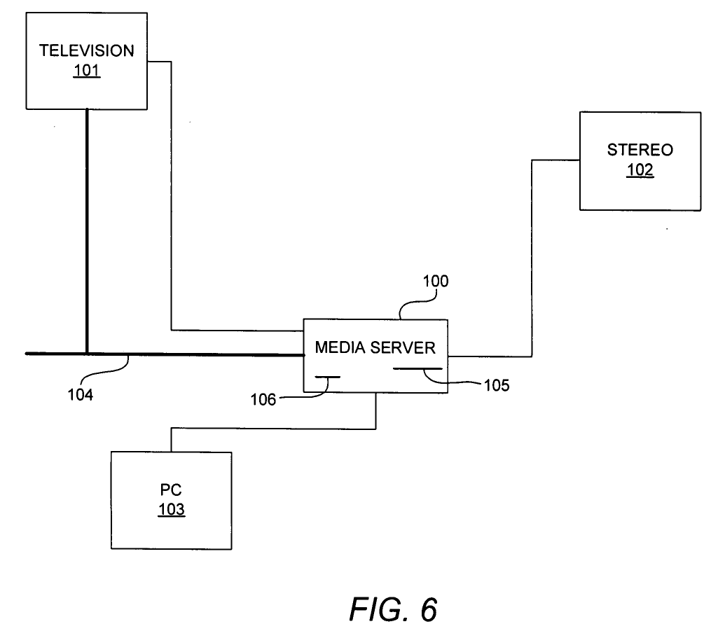

FIG. 6 illustrates a block diagram of an example of the apparatus implemented as a media server 100. The media server 100 is configured to interface with a variety of different types of devices, including, for example, a television 101, a stereo 102, a PC 103, and the Community Antenna Television (CATV) coaxial cable 104 that provides television programming, music, etc., and/or Internet access. The media server 100 typically includes a DVD player and burner 105 and a flash memory card reader 106. The media server 100 may or may not include a touch screen monitor. The media server 100 connects to the television 101 by a standard video or high-definition multimedia interface (HDMI) connection. The media server 100 connects to the stereo 102 by standard audio cables or by a Sony/Philips Digital Interface (SPDIF) cable, also known as an IEC 958 type II cable. Typically, the television 101 will function as the display for the media server 100.

The media server 100 includes data storage (not shown) in which the metadata database described above with reference to FIGS. 1-5 is stored. The media server 100 is programmed to execute the metadata software program 40 described above with reference to FIGS. 1-5. The metadata database stored in media server 100 is initialized in the manner described above with reference to FIGS. 2 and 3. This may be accomplished using the PC 103, in which case the media server 100 will cause the metadata to be presented to the user on a display monitor (not shown) of the PC. Alternatively, initialization may be accomplished through direct interaction between the user and the media sever 100 as metadata selections are displayed on the television 101.

When a user desires to download digital photographs taken by a digital camera (not shown) to the media server 100, the user may plug the digital camera into a USB port (not shown) of the media server 100 and download the photographs from the camera to the media server 100. Alternatively, the user may remove the flash memory card (not shown) from the camera and insert it into the card reader 106 and download the photographs from the memory card to the media server 100. As downloading is taking place, the image files may be associated with metadata as the user makes appropriate selections from the options displayed in a menue such as menu 80 on the television 101. This facilitates the process of associating the image files with metadata because the user is not required to enter any information via keyboard. A mouse (not shown) connected to the console of the media server 100 or a television remote control may be used to make the appropriate selections.

The metadata with which the image file has been associated and the photograph itself may be stored in storage in the media server 100 or in some other storage component that is separate from the media server 100. Typically, the metadata database and the archives (i.e., the image files and associated metadata) are stored in the same database in the media server 100.

The media server 100 may also be used to search the archives, generate photo albums, etc. The media server 100 is typically configured to enable the photographs of image files that are stored in the archives to be displayed on the television 101, which is typically a high-definition television. Because much of the metadata is standardized, searches are made easier because text strings that are used to perform searches and other tasks associated with the archives are easily remembered or can be easily looked up in a user manual.

Although the apparatus has been described as being implemented by a computer, such as the processor 10 shown in FIG. 1 or the media server 100 shown in FIG. 3, the apparatus may be any type of computational device capable of performing the tasks described above with reference to the computer program 40 and the flow diagram shown in FIG. 2. Therefore, the term computational device will be used herein to denote any computer capable of performing these tasks. Also, although the method has been described as being performed in software being executed by a computer, the method may be performed also be performed solely in hardware or in a combination of hardware and software or firmware.

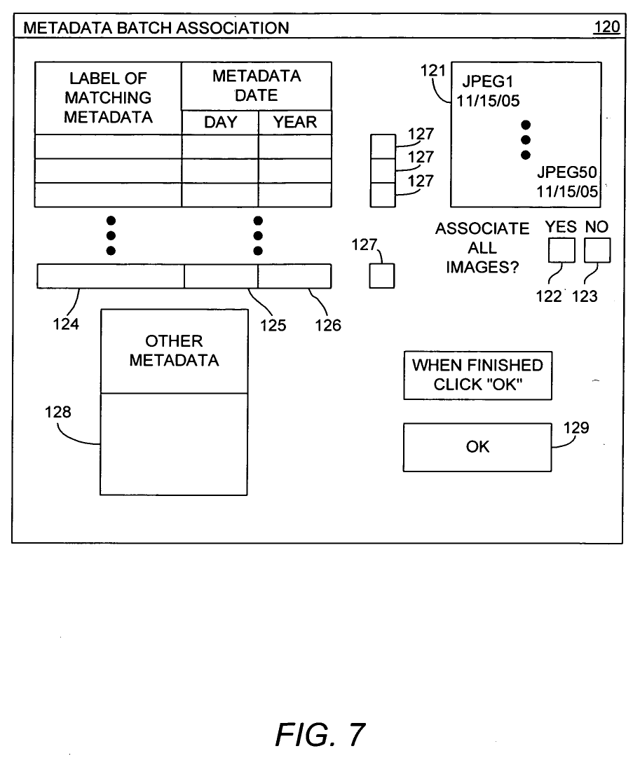

FIG. 7 illustrates a menu 120 in accordance with another embodiment that enables metadata to be automatically associated with multiple digital photographs taken on the same day. This feature allows multiple image files to be batch processed, rather than being processed one at a time. Boxes 124-127 shown in FIG. 7 may be identical to boxes 84-87, respectively, shown in FIG. 5. In box 121, multiple images corresponding to photographs taken on the same day will be identified. Box 122 is selected if the user wishes to associate all of the image files with the same metadata presented in boxes 124-126 and/or 128. The user selects the box or boxes 127 that correspond to the appropriate metadata with which the image files are to be associated. If the user does not wish to associate all of the images with the same metadata, the user selects box 123. If the user selects box 122 and then selects the “OK” button 129, all of the image files will automatically be associated with the presented metadata that was selected by the user. If the user selects box 123 and then selects the “OK” button 129, the image files will not be associated with the same metadata.

The menu 120 may be presented to the user automatically at the time of downloading. Alternatively, the user may cause the menu 120 to be displayed at a time subsequent to downloading by entering a corresponding command. For example, a selection option may be provided in menu 80 that allows the user to indicate that the image displayed in box 81 is part of a batch of images captured on the same day that are to be batch processed.

It should be noted that the invention has been described with reference to particular examples and that the invention is not limited to the examples described herein. Those skilled in the art will understand that modifications may be made to the examples described above and that all such modifications are within the scope of the invention.

What is claimed is:

1. An apparatus for automatically selecting and presenting metadata, the apparatus comprising:
a computational device, the computational device being configured to automatically select metadata and to present the automatically selected metadata to a user, the computational device automatically selecting metadata based on a comparison of information included in an image file and information included in a metadata database, the image file including a digital photograph and other information.

2. The apparatus of claim 1, further comprising:
a storage component, the metadata database being stored in the storage component.

3. The apparatus of claim 2, wherein the information included in the image file includes a date when the digital photograph was taken, and wherein the information included in the metadata database includes dates, the computational device automatically selecting metadata based on a comparison of the date when the digital photograph was taken and one or more dates contained in the metadata database.

4. The apparatus of claim 2, wherein the information included in the image file includes a date and time when the digital photograph was taken, and wherein the information included in the metadata database includes dates and times, the computational device automatically selecting metadata based on a comparison of the date and time when the digital photograph was taken and one or more dates and times contained in the metadata database.

5. The apparatus of claim 1, wherein the computational device is configured to detect an indication by the user as to whether or not the presented metadata is approved for association with the digital photograph included in the image file, wherein if the computational device detects said indication, the computational device causes the presented metadata to be associated with the image file.

6. The apparatus of claim 5, wherein the computational device is configured to detect an indication by the user as to whether or not the presented metadata is approved for association with the digital photograph included in the image file and other digital photographs taken on a same date.

7. The apparatus of claim 5, wherein the metadata and associated image file are stored in the storage component.

8. The apparatus of claim 5, wherein the metadata and associated image file are stored in a storage component that is separate from the storage component in which the metadata database is stored.

9. The apparatus of claim 1, wherein the comparison occurs during downloading of the image file to the computational- device or to a device that is in communication with the computational device.

10. The apparatus of claim 3, wherein at least some of the dates stored in the metadata database correspond to dates of holidays.

11. The apparatus of claim 10, wherein at least one of the dates stored in the metadata database corresponds to a person's birthday.

12. The apparatus of claim 5, wherein the computational device is in communication with a display screen, and wherein the user approves presented metadata by using an input device to make a selection from presented metadata that is displayed on the display screen, the computational device receiving an indication that the user has made the selection approving the presented metadata and causing the approved metadata and the associated image file to be stored in a storage component.

13. The apparatus of claim 5, further comprising:
a display monitor in communication with the computational device, the presented metadata being displayed on the display monitor, the user indicating approval of presented metadata by making a selection on the display monitor, the computational device receiving the indication and causing the approved metadata and associated image file to be stored in a storage component.

14. An apparatus for initializing a metadata database, the apparatus comprising:
a computational device, the computational device causing standard metadata to be presented to a user on a display monitor for approval by the user; and
a storage component, the computational device causing approved metadata to be stored in a metadata database in the storage component.

15. The apparatus of claim 14, wherein the standard metadata includes names and dates of holidays.

16. The apparatus of claim 15, wherein the computational device receives input from the user in a form of names and birthdates of people, the names and birthdates corresponding to recurring personal metadata, the computational device combing the approved standard metadata with the recurring personal metadata in the metadata database stored in the storage component.

17. A method for automatically selecting and presenting metadata, the method comprising:
automatically selecting metadata from a metadata database for presentation to a user based on a comparison of information included in an image file and information included in the metadata database, the image file including a digital photograph and other information; and
presenting the automatically selected metadata to a user by displaying the automatically selected metadata on a display device.

18. The method of claim 17, further comprising:
detecting an indication by the user as to whether or not the presented metadata is approved for association with the image file; and
if the computational device detects said indication, storing the metadata that has been approved by the user and the image file with which the approved metadata is to be associated in a storage component.

19. The method of claim 17, wherein the information included in the image file includes a date when the digital photograph was taken, and wherein the information included in the metadata database includes dates, and wherein the automatic selection of metadata is based on a comparison of the date when the digital photograph was taken and one or more dates contained in the metadata database.

20. The method of claim 17, wherein the information included in the image file includes a date and time when the digital photograph was taken, and wherein the information included in the metadata database includes dates and times, and wherein the automatic selection of metadata is based on a comparison of the date and time when the digital photograph was taken and one or more dates and times contained in the metadata database.

21. The method of claim 17, wherein the comparison occurs during downloading of the image file to a computational device.

22. The method of claim 17, wherein at least some of the dates stored in the metadata database correspond to dates of holidays.

23. The method of claim 17, wherein at least one of the dates stored in the metadata database corresponds to a person's birthday.

24. A computer program for automatically selecting and presenting metadata, the program being embodied on a computer-readable medium, the program comprising:
code for automatically selecting metadata from a metadata database for presentation to a user based on a comparison of information included in an image file and information included in the metadata database, the image file including a digital photograph and other information; and
code for causing the automatically selected metadata to be displayed on a display device.

25. The compute program of claim 23, further comprising:
code for detecting an indication by the user as to whether or not the displayed metadata is approved for association with the image file; and
code for storing displayed metadata that has been approved by the user and the image file with which the approved metadata is to be associated in a storage component.
